(19) United States
(12) Patent Application Publication
(10) Pub. No.: US 2014/0327995 A1
(43) Pub. Date: Nov. 6, 2014

(54) SYSTEM FOR DISCONNECTING ELECTRICAL POWER UPON REGULATION FAILURE

(71) Applicant: Husky Injection Molding Systems Ltd., Bolton (CA)

(72) Inventors: Vijay Gopichand Panjwani, Brampton (CA); Endel Robert Mell, Unionville (CA)

(21) Appl. No.: 14/362,180

(22) PCT Filed: Nov. 29, 2012
(86) PCT No.: PCT/CA2012/050860

§ 371 Date: Jun. 2, 2014

Related U.S. Application Data
(60) Provisional application No. 61/577,216, filed on Dec. 19, 2011.
(60) Provisional application No. 61/586,223, filed on Jan. 13, 2012.

(51) Int. Cl. H02H 3/08

(52) U.S. Cl. CPC H02H 3/08
USPC 361/93.1

(57) ABSTRACT

A system (100), comprising: a load-regulation assembly (102) configured to regulate flow of electrical power from a line-power terminal (899); and a load-disconnection assembly (104) being configured to disconnect the flow of electrical power from the line-power terminal (899) for the case where the load-regulation assembly (102) fails to regulate the flow of electrical power from the line-power terminal (899).

### TECHNICAL FIELD

Aspects generally relate to (and not limited to) a system for disconnecting electrical power upon regulation failure including (and not limited to) molding systems having the system for disconnecting electrical power upon regulation failure.

### BACKGROUND

U.S. Pat. No. 3,936,699 discloses a ground fault detection circuit.

U.S. Pat. No. 4,149,210 discloses a circuit breaker.

U.S. Pat. No. 4,370,692 discloses a ground fault interrupter type device.

U.S. Pat. No. 5,654,857 discloses a ground fault circuit interrupt system.

U.S. Pat. No. 5,841,615 discloses a ground fault circuit interrupt system.

### SUMMARY

A drawback of the known single-use fuse assembly is that it is used once (since they self-destructively blow) and then need subsequent replacement with a replacement fuse assembly. The single-use fuse assembly occupies a lot of space and generates a lot of unwanted (undesirable) heat. This additional unwanted heat may also inadvertently (undesirably) affect performance of adjacently-located components. The reliability of the adjacently-located components is increased if they are operated within their nominal temperature range. Single-blow fuse assemblies require replacement after each trip event. Both short circuit and overload conditions may result in over-current conditions, which lead to self-destruction of the fuse assembly. Single-use fuses may experience nuisance operation when they respond to low level overloads, and subsequently may then need replacement. This results in unnecessary downtime of equipment, such as a molding system.

In order to mitigate, at least in part, at least some of the above-identified problems, according to a first aspect of the solution, there is provided a system (100); the system (100) comprises (and is not limited to): a load-disconnection assembly (104) configured to disconnect flow of electrical power from a line-power terminal (899) for the case where a load-regulation assembly (102) fails to regulate the flow of electrical power from the line-power terminal (899), and the load-regulation assembly (102) is configured to regulate the flow of electrical power from the line-power terminal (899).

In order to mitigate, at least in part, at least some of the above-identified problems, according to a second aspect of the solution, there is provided a system (100); the system (100) comprises (and is not limited to): (i) a load-regulation assembly (102) configured to regulate flow of electrical power from a line-power terminal (899); and (ii) a load-disconnection assembly (104) being configured to disconnect the flow of electrical power from the line-power terminal (899) for the case where the load-regulation assembly (102) fails to regulate the flow of electrical power from the line-power terminal (899).

In order to mitigate, at least in part, at least some of the above-identified problems, according to a third aspect of the solution, there is provided a method; the method comprises (and is not limited to): (i) regulating flow of electrical power from a line-power terminal (899); and (i) disconnecting the flow of electrical power from the line-power terminal (899) for the case where there is a failure to regulate the flow of electrical power from the line-power terminal (899).

Other aspects to the solution are described in the description section and/or the claims section.

Generally speaking, the system (100) may be made more compact and more reliable than the known single-use fuse assemblies. The system (100) may operate more reliably and may require a smaller heat sink versus the known single-use fuse assembly. The system (100) may also provide the characteristics of known single-use fuse assemblies without emitting the unwanted heat produced by the single-use fuse assemblies.

Other aspects and features of the non-limiting embodiments will now become apparent to those skilled in the art upon review of the following detailed description of the non-limiting embodiments with the accompanying drawings.

### DETAILED DESCRIPTION OF THE DRAWINGS

The non-limiting embodiments will be more fully appreciated by reference to the following detailed description of the non-limiting embodiments when taken in conjunction with the accompanying drawings, in which:

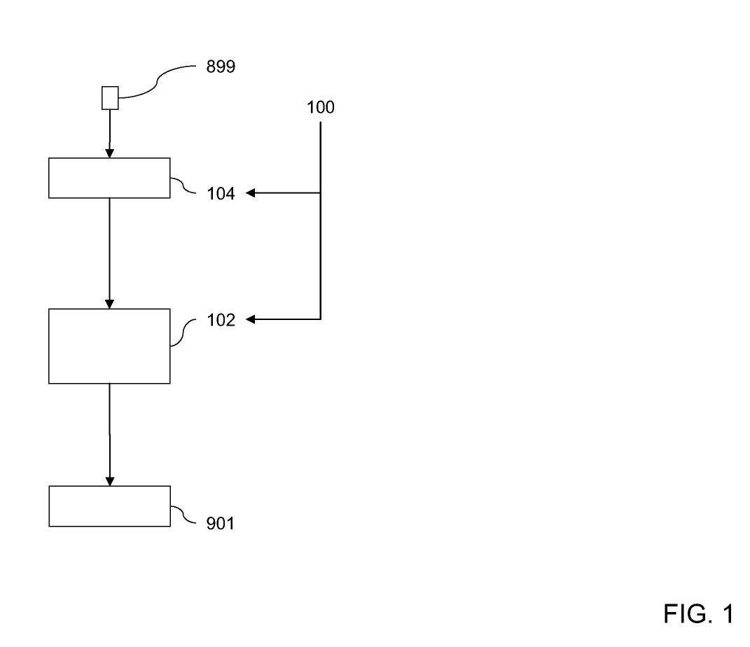

FIGS. 1, 2, 3, 4 depict examples of schematic representations of a system (100).

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF THE NON-LIMITING EMBODIMENT(S)

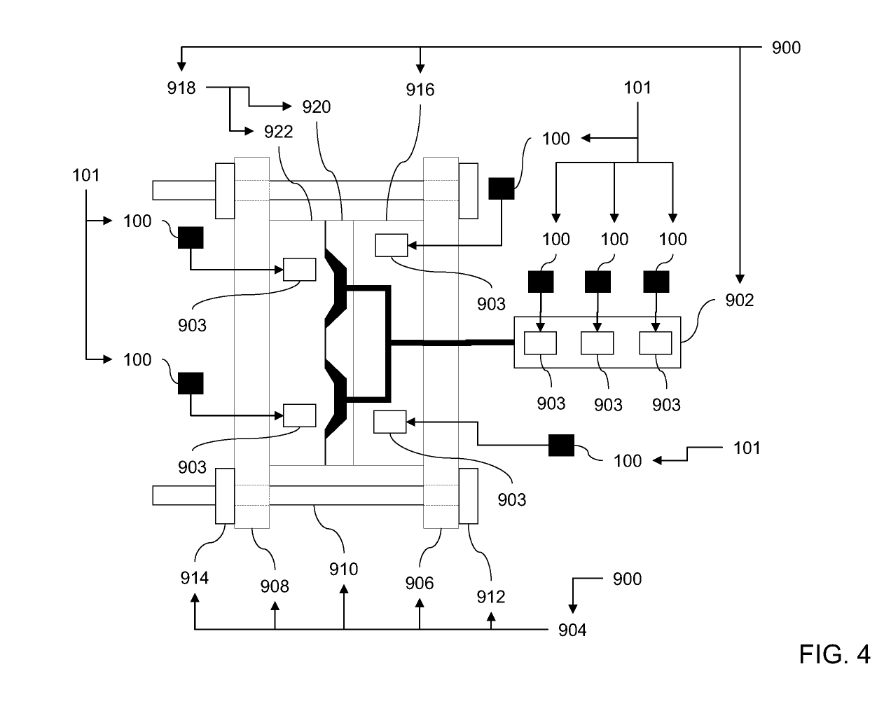

Referring now to FIG. 1, there is depicted, generally speaking, an example of the schematic representation of the system (100). The system (100) is configured for controlling flow of electrical power from a line-power terminal (899) to a load assembly (901). By way of example, the load assembly (901) may include (and is not limited to) a heater assembly (903) of FIG. 4 that may be used on a molding system (900) for the purpose of heating a mold assembly (918), or may be used to heat an extruder assembly (902).

According to a first general aspect, the system (100) includes (and is not limited to): a load-disconnection assembly (104) configured to disconnect flow of electrical power from the line-power terminal (899) for the case where the load-regulation assembly (102) fails to regulate the flow of electrical power from the line-power terminal (899). The load-regulation assembly (102) is configured to regulate the flow of electrical power from the line-power terminal (899).

According to a second general aspect, the system (100) includes (and is not limited to) a combination of both the load-regulation assembly (102) and the load-disconnection assembly (104).

The load-disconnection assembly (104) and the load-regulation assembly (102) are configured in combination to connect (directly or indirectly) the line-power terminal (899) to a load assembly (901) so that electrical power flows from the line-power terminal (899) to the load assembly (901).

Generally speaking, the load-regulation assembly (102) is configured to regulate flow of electrical power from the line-power terminal (899). It will be appreciated that “regulate” means to control or direct by a method, to adjust to some standard or requirement, to adjust so as to ensure accuracy of operation, to change (increase, decrease, and/or to disconnect). By way of example (according to an option), the load-regulation assembly (102) includes (and is not limited to): a solid-state component or element, such as: a TRIAC (Triode for Alternating Current), an SCR (Silicon Controlled Rectifier), a complimentary MOSFET (Metal-Oxide-Semiconductor Field-Effect Transistor), a solid-state relay (SSR), etc. The load-regulation assembly (102) may be defined as an assembly that does not physically break contact in a power line, but may stop flow of current flowing through the power line. It will be appreciated that the load-regulation assembly (102) may include (and is not limited to) a solid-state component and/or a non-solid state component (such as a mechanical relay, an electro-mechanical switch, etc).

The load-disconnection assembly (104) is configured to disconnect the flow of electrical power from the line-power terminal (899) for the case where the load-regulation assembly (102) fails to regulate the flow of electrical power from the line-power terminal (899). By way of example, the load-disconnection assembly (104) includes (and is not limited to) an electro-mechanical switch having, for example, relay contacts. The load-disconnection assembly (104) may be defined as an assembly that physically breaks contact in a power line in order to stop flow of current from the line-power terminal (899). The load-disconnection assembly (104) is reusable unlike the known single-use single-blow fuse assembly. By way of another example, the load-disconnection assembly (104) may include (and is not limited to): a solid-state component and/or a non-solid state component (such as a mechanical relay, an electro-mechanical rely, etc). The physical and electrical isolation between the input terminals (120) and the line-power terminal (899) may be provided by the electromechanical relay contacts of the load-disconnection assembly (104).

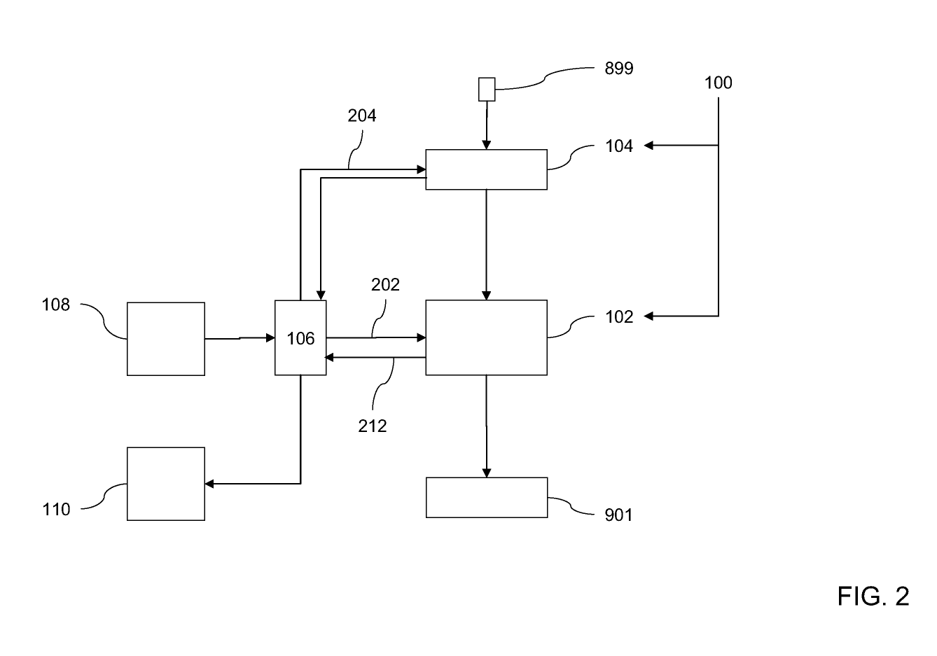

It will be appreciated that the above statements associated with the system (100) of FIG. 1 are also applicable to describing, in general terms, the system (100) depicted in FIGS. 2, 3, 4.

Referring now to FIG. 2, there is depicted a more specific example of the system (100), in which the system (100) further includes (and is not limited to) a controller assembly (106). The controller assembly (106) may be a digital processing unit (digital processor, a central-processing unit, etc) and/or may be an analogue controller (analogue computer).

Generally speaking, the controller assembly (106) is configured to communicate (send and/or receive) signals and/or commands with the load-disconnection assembly (104) and with the load-regulation assembly (102). For example, the controller assembly (106) is also configured to send a regulation-command signal (202) to be received by the load-regulation assembly (102). The regulation-command signal (202) is configured to command the load-regulation assembly (102) to regulate the flow of electrical power from the line-power terminal (899). The controller assembly (106) is configured to send a disconnection command signal (204) to be received by the load-disconnection assembly (104). The disconnection command signal (204) is configured to command the load-disconnection assembly (104) to disconnect the flow of electrical power from the line-power terminal (899) for the case where the load-regulation assembly (102) fails to regulate the flow of electrical power from the line-power terminal (899). The controller assembly (106) is configured to receive an indicating signal (212) from the load-regulation assembly (102), and the indicating signal (212) is configured to indicate an attribute of the electrical power (the attribute may be the amount of sensed current, etc) associated with the flow of electrical power from the line-power terminal (899).

The load-disconnection assembly (104) is configured to: (i) couple (either directly or indirectly) to the line-power terminal (899), and (ii) disconnect (either directly or indirectly) the flow of electrical power from the line-power terminal (899) in response to receiving the disconnection command signal (204). The disconnection command signal (204) is configured to command the load-disconnection assembly (104) to disconnect the flow of electrical power from the line-power terminal (899).

The load-regulation assembly (102) is configured to: (i) couple (either directly or indirectly) to the load assembly (901), (ii) couple (either directly or indirectly) to the load-disconnection assembly (104), so that electrical power flows, in use, from the line-power terminal (899) to the load assembly (901) via the load-disconnection assembly (104) and the load-regulation assembly (102), (iii) provide the indicating signal (212), (iv) regulate (either directly or indirectly) the flow of electrical power from the line-power terminal (899) in response to receiving the regulation-command signal (202) from the controller assembly (106). It will be appreciated that the term “regulate” means to disconnect completely, to change, to reduce, to increase, etc.

The controller assembly (106) is configured to: (i) couple (either directly or indirectly) to the load-disconnection assembly (104), (ii) couple (either directly or indirectly) to the load-regulation assembly (102), (iii) receive (either directly or indirectly) the indicating signal (212) from the load-regulation assembly (102), and (iv) send (either directly or indirectly) the regulation-command signal (202) to the load-regulation assembly (102), and (v) send the disconnection command signal (204) to the load-disconnection assembly (104).

For the case where the load-disconnection assembly (104) fails to operate, the controller assembly (106) is configured to: send (either directly or indirectly), the regulation-command signal (202) to the load-regulation assembly (102), and the regulation-command signal (202) is also further configured to command the load-regulation assembly (102) to disconnect the flow of electrical power from the line-power terminal (899), since load-disconnection assembly (104) failed to operate or to be responsive to the disconnection command signal (204).

For the case where the load-regulation assembly (102) fails to operate, the controller assembly (106) is configured to: send (either directly or indirectly) the disconnection command signal (204) to the load-disconnection assembly (104), in which case the disconnection command signal (204) is also further configured to command the load-disconnection assembly (104) to disconnect the flow of electrical power from the line-power terminal (899), since the load-regulation assembly (102) failed to be responsive to the regulation-command signal (202) or other reason for failure.

For the case where the controller assembly (106) fails to communicate with the load-disconnection assembly (104), then the load-regulation assembly (102) operates or functions to disconnect the flow of electrical power from the line-power terminal (899). It will be appreciated that (for example) a periodic handshake between the controller assembly (106) and the load-disconnection assembly (104) may take place in order to prevent the load-disconnection assembly (104) from disconnecting the flow of electrical power from the line-power terminal (899).

For the case where the controller assembly (106) fails to communicate with the load-regulation assembly (102), the load-disconnection assembly (104) disconnects the flow of electrical power from the line-power terminal (899). It will be appreciated that (for example) a periodic handshake between the controller assembly (106) and the load-regulation assembly (102) may take place in order to prevent the load-regulation assembly (102) from disconnecting the flow of electrical power from the line-power terminal (899).

For the case where the load-regulation assembly (102) detects an electrical fault condition associated with the flow of electrical power from the line-power terminal (899), the load-regulation assembly (102) is further configured to disconnect the flow of electrical power from the line-power terminal (899). For this case, the load-regulation assembly (102) may include a dedicated controller unit (not depicted) that uses its own executable instructions for making local decisions for directing the load-regulation assembly (102) to disconnect the flow of electrical power.

For the case where the load-regulation assembly (102) detects an electrical fault condition associated with the flow of electrical power from the line-power terminal (899), the load-regulation assembly (102) is further configured to issue a command signal to the load-disconnection assembly (104) to disconnect the flow of electrical power from the line-power terminal (899). For this case, the load-regulation assembly (102) may include a dedicated controller unit (not depicted) that uses its own executable instructions for making local decisions for directing the load-regulation assembly (102) to disconnect the flow of electrical power by way of a command signal to the load-disconnection assembly (104).

For a case where the controller assembly (106) determines that the load-regulation assembly (102) is operational, the controller assembly (106) uses the load-regulation assembly (102) to control (regulate) the flow of electrical power to the load assembly (901).

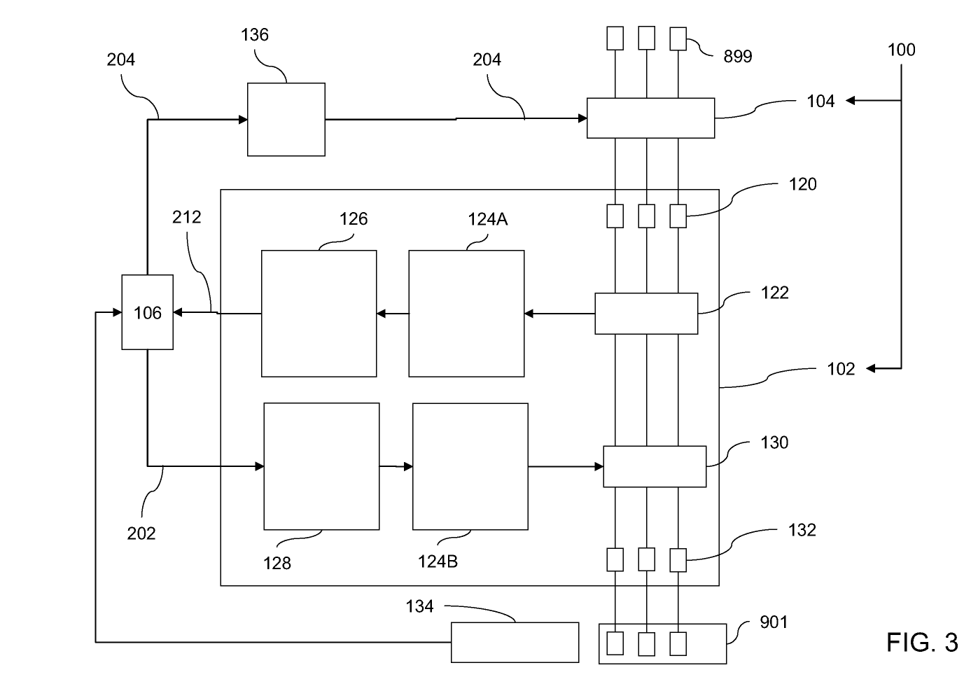

More specifically, the controller assembly (106) is configured to control operation of the load-disconnection assembly (104) and the load-regulation assembly (102), by way of interfacing components that are described further below and depicted in FIG. 3. According to the example depicted in FIG. 2, a memory assembly (108) is coupled to the controller assembly (106). A human-machine interface assembly (110) may be connected to the controller assembly (106) so that an operator of the system (100) may adjust operation of the system (100) by way of programming the controller assembly (106). The human-machine interface assembly (110) may include (by way of example and not limited to): a display unit, a keyboard, pointer device, etc. The memory assembly (108) tangibly embodies processor-executable instructions configured to direct the controller assembly (106) to perform various functions or tasks (methods or method steps or operations steps).

According to an option, a single centralized power supply (known and not depicted) may be used to supply and to the control electrical power to the controller assembly (106) and to each system (100) for the case where a plurality of the system (100) is used. The single (central) power supply may be connected to the line-power terminal (899). The controller assembly (106) executes the processor-executable instructions (a control program) stored in the memory assembly (108). The system (100) may be assembled on a single module and/or a single card that is mountable or receivable in an industrial-rack system (known and not depicted) along with controller assembly (106) if so desired.

By way of example, the controller assembly (106) is configured to carry out executable instructions of a controller-executable program, to perform the basic arithmetical, logical, and input/output operations. The controller assembly (106) may require one or more printed circuit boards. The controller assembly (106) may be housed in a single chip called a microprocessor. Two components of the controller assembly (106) are the arithmetic logic unit (ALU), which performs arithmetic and logical operations, and the control unit (CU), which extracts instructions from memory and decodes and executes them, calling on the ALU when necessary. The controller assembly (106) may include (and is not limited to): an array processor or vector processor that has multiple parallel computing elements, with no one unit considered the “center”. For the case of distributed computing model, the controller assembly (106) operates by a distributed interconnected set of processors.

Referring now to FIG. 3, there is depicted a more detailed example of the system (100). The system (100) of FIG. 3 is further adapted such that the load-regulation assembly (102) includes (and is not limited to): input terminals (120), a current sensor (122), a first optical-isolation assembly (124A), an analogue-to-digital converter assembly (126), a power-control assembly (128), a second optical-isolation assembly (124B), a solid-state load switch assembly (130), and output terminals (132), and the thermal-sensor assembly (134). The input terminals (120) are configured to connect (directly or indirectly) to the load-disconnection assembly (104). The current sensor (122) is configured to detect (sense) and to provide an indication of an amount of electrical current flowing from the line-power terminal (899). The first optical-isolation assembly (124A) is connected to the current sensor (122). The first optical-isolation assembly (124A) is configured to physically (and electrically) isolate the current sensor (122) from the remainder of the components used in the load-regulation assembly (102). The analogue-to-digital converter assembly (126) is connected to the first optical-isolation assembly (124A). The measured (sensed, detected) current signal is provided to the analogue-to-digital converter assembly (126) via the first optical-isolation assembly (124A). The analogue-to-digital converter assembly (126) outputs a digital signal of the measured current based on multiple discrete samples of the measured analog current that was measured by the current sensor (122). The analogue-to-digital converter assembly (126) is connected to the controller assembly (106).

The controller assembly (106) is programmed, via the processor-executable instructions stored in the memory assembly (108), to evaluate the digital current signal that represents the analogue current passing through the load assembly (901). The controller assembly (106) compares the digital value to a pre-programmed set value of the tripping current (or a pre-programmed current versus time characteristic) that is stored in the memory assembly (108). Based on the ratio of the comparison made by the controller assembly (106), the controller assembly (106) makes a decision (based on pre-programmed executable instructions) to do nothing, or to send a command signal to shut off the flow of electrical power (current) to the load assembly (901): that is, to open the circuit and stop the flow of current based on a ratio of the current comparison (for example) made by the controller assembly (106). The controller assembly (106) may log (that is, record) the actual currents to the memory assembly (108), as well as log or record the events when the measured current exceeds the pre-set current values. Furthermore, the controller assembly (106) may also send the logged information back to a machine-control IPC (Industrial Programmable Computer, not depicted but known) of the molding system (900) of FIG. 4 via an industrial bus, such as the EtherCAT (Ethernet for Control Automation Technology) for example. The machine control IPC may also program the current trip values (or characteristic curves) remotely through the industrial bus. The controller assembly (106) may enable the system (100) to monitor additional functions, such as (and not limited to) power and voltage.

The power-control assembly (128) is connected to the controller assembly (106). The second optical-isolation assembly (124B) is connected to the power-control assembly (128). The second optical-isolation assembly (124B) is configured to electrically and physically isolate the power-control assembly (128) from the solid-state load switch assembly (130) by way of the line-power terminal (899) or the load assembly (901). The solid-state load switch assembly (130) is connected to the second optical-isolation assembly (124B). The power-control assembly (128) is configured to control the solid-state load switch assembly (130) that switches the current to the load assembly (901) ON or OFF based on the signals provided by the controller assembly (106). Examples of the solid-state load switch assembly (130) includes (and is not limited to): a solid-state electronic component (such as) a TRIAC (Triode for Alternating Current), an SCR (Silicon Controlled Rectifier), or a complimentary MOSFET (Metal-Oxide-Semiconductor Field-Effect Transistor). The solid-state load switch assembly (130) is configured to permit flow of (and to regulate) electrical power (such as current) from the line-power terminal (899) to the load assembly (901), and is also configured to disconnect the flow of electrical power (current) the line-power terminal (899) to the load assembly (901). The output terminals (132) are configured to connect (directly or indirectly) the solid-state load switch assembly (130) to the load assembly (901). The thermal-sensor assembly (134) is configured to sense an amount of temperature associated with operation of the load assembly (901). The thermal-sensor assembly (134) is connected (either directly or indirectly by way of a communication-bus system) to the controller assembly (106), either directly or indirectly by way of a network connection, etc. The system (100) may further include (and is not limited to) an interface circuit (136) connecting the controller assembly (106) to the load-disconnection assembly (104). By way of example, the interface circuit (136) includes (and is not limited to) a programmable-logic controller.

The sensing-control loop includes the following components: (i) the current sensor (122), the first optical-isolation assembly (124A) and the second optical-isolation assembly (124B), the analogue-to-digital converter assembly (126), the controller assembly (106), the power-control assembly (128), the solid-state load switch assembly (130), and the executable program that is associated with the controller assembly (106). By way of example, a way to ensure appropriate treatment for the sensing—control loop is to follow the methodology described in standards, such as IEC (International Electrotechnical Commission) Standard 61580 and/or IEC Standard 62061.

Actual performance of the system (100) may be tested in accordance with pass/fail criteria drawn from known, recognized standards, such as UL (Underwriters Laboratory) Standard 248 (fuses) and/or UL Standard 489 (circuit breakers), combined with other requirements associated with relevant safety design process (if so desired). The UL standards provide a source of construction and performance requirements for more conventional branch circuit protective circuit elements.

The safety relevant design method that may be followed may map key performance requirements from the accepted standards to the requirements of the system (100).

It will be appreciated that the system (100), as depicted in FIG. 3, is configured for a single zone-heat control. It is contemplated that the system (100) may be used in a multiple zone-heat control, as depicted in FIG. 4.

Referring now to another specific example as depicted in FIG. 4, the molding system (900) is depicted for the case in which there is a plurality of the load assembly (901). The molding system (900) may also be called (for example) an injection-molding system. The molding system (900), as depicted in FIG. 4, has the system (100) as described above. It will be appreciated that existing molding systems may be retrofitted with the system (100). In addition, new molding systems may be equipped with the system (100) when sold to an end user. As depicted in FIG. 4, the system (100) includes (and is not limited to) a plurality of the load-disconnection assembly (104), and a plurality of the load-regulation assembly (102) as may be required for each instance of the load assembly (901).

The load assembly (901) includes a plurality of heater assemblies (903) connected to or with the molding system (900). A multi-zone heater system (101) includes (and is not limited to) at least one or more of the system (100): that is, a plurality of the system (100). The multi-zone heater system (101) is configured to control the heater assemblies (903) connected to the molding system (900). The multi-zone heater system (101) may be used (for example) for controlling heating zones of an extruder assembly (902), and/or a runner system (916) and/or a mold assembly (918). It will be appreciated that the system (100) may be used for protection of electrical motor loads as well, if so desired.

The molding system (900) includes (and is not limited to): (i) an extruder assembly (902), (ii) a clamp assembly (904), (iii) a runner system (916), and/or (iv) a mold assembly (918). By way of example, the extruder assembly (902) is configured, to prepare, in use, a heated, flowable resin, and is also configured to inject or to move the resin from the extruder assembly (902) toward the runner system (916). Other names for the extruder assembly (902) may include injection unit, melt-preparation system, etc. By way of example, the clamp assembly (904) includes (and is not limited to): (i) a stationary platen (906), (ii) a movable platen (908), (iii) a rod assembly (910), (iv) a clamping assembly (912), and/or (v) a lock assembly (914). The stationary platen (906) does not move; that is, the stationary platen (906) may be fixedly positioned relative to the ground or floor. The movable platen (908) is configured to be movable relative to the stationary platen (906). A platen-moving mechanism (not depicted but known) is connected to the movable platen (908), and the platen-moving mechanism is configured to move, in use, the movable platen (908). The rod assembly (910) extends between the movable platen (908) and the stationary platen (906). The rod assembly (910) may have, by way of example, four rod structures positioned at the corners of the respective stationary platen (906) and the movable platen (908). The rod assembly (910) is configured to guide movement of the movable platen (908) relative to the stationary platen (906). A clamping assembly (912) is connected to the rod assembly (910). The stationary platen (906) supports the position of the clamping assembly (912). The lock assembly (914) is connected to the rod assembly (910), or may alternatively be connected to the movable platen (908). The lock assembly (914) is configured to selectively lock and unlock the rod assembly (910) relative to the movable platen (908). By way of example, the runner system (916) is attached to, or is supported by, the stationary platen (906). The runner system (916) is configured to receive the resin from the extruder assembly (902). By way of example, the mold assembly (918) includes (and is not limited to): (i) a mold-cavity assembly (920), and (ii) a mold-core assembly (922) that is movable relative to the mold-cavity assembly (920). The mold-core assembly (922) is attached to or supported by the movable platen (908). The mold-cavity assembly (920) is attached to or supported by the runner system (916), so that the mold-core assembly (922) faces the mold-cavity assembly (920). The runner system (916) is configured to distribute the resin from the extruder assembly (902) to the mold assembly (918).

In operation, the movable platen (908) is moved toward the stationary platen (906) so that the mold-cavity assembly (920) is closed against the mold-core assembly (922), so that the mold assembly (918) may define a mold cavity configured to receive the resin from the runner system (916). The lock assembly (914) is engaged so as to lock the position of the movable platen (908) so that the movable platen (908) no longer moves relative to the stationary platen (906). The clamping assembly (912) is then engaged to apply a camping pressure, in use, to the rod assembly (910), so that the clamping pressure then may be transferred to the mold assembly (918). The extruder assembly (902) pushes or injects, in use, the resin to the runner system (916), which then the runner system (916) distributes the resin to the mold cavity structure defined by the mold assembly (918). Once the resin in the mold assembly (918) is solidified, the clamping assembly (912) is deactivated so as to remove the clamping force from the mold assembly (918), and then the lock assembly (914) is deactivated to permit movement of the movable platen (908) away from the stationary platen (906), and then a molded article may be removed from the mold assembly (918).

The molding system (900) may include components that are known to persons skilled in the art, and these known components will not be described here; these known components are described, at least in part, in the following reference books (for example): (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Systems” 3^{rd} Edition authored by JOHANNABER (ISBN 3-446-17733-7) and/or (iv) “Runner and Gating Design Handbook” authored by BEAUMONT (ISBN 1-446-22672-9).

A centralized power supply (known and not depicted) and the controller assembly (106) provide power and provide control (respectively) to each of system (100) that is deployed to or used on the molding system (900). The system (100) may either control a single heating zone or control multiple heating zones based on feedback from a single and/or a purality of the thermal-sensor assembly (134) that are associated with the heater assemblies (903). Each system (100) protects, in use, against over-current and short circuit for each of the heating zones. The current passing through the heater assemblies (903) may vary widely from at or below nominal continuous (allowable) current to overload current levels that may be two or three times the nominal continuous current and to short circuit currents that may be tens or hundreds of times greater than the nominal continuous current. The controller assembly (106) is configured to adjust (in use) the time to open the solid-state load switch assembly (130) to the shortest time possible (if so desired). The current-time characteristics may be pre-programmed and stored in the memory assembly (108) of FIG. 2. The processor-executable instructions stored in the memory assembly (108) are configured to direct the controller assembly (106) to record the measured currents of each heating zone, and to store the measured current when a current fault has occurred (or optionally, to continuously record the measured current values whether or not a fault has occurred). The controller assembly (106) can also send the saved data to a remote-interface unit (not depicted) using a real time industrial communication interface bus (known and not depicted). The load-regulation assembly (102) may include (and is not limited to): (i) semiconductor power devices (SCR's), (ii) a heat sink for the semiconductor power devices, (iii) a control circuit for the semiconductor power devices, (iv) a protective circuit. A reset circuit (not depicted) may be incorporated in the system (100) that would allow the operator to (manually) reset the system (100) once the cause of tripping of the system (100) has been found or determined. By using the controller assembly (106), the value of the current that causes the tripping of system (100) and the tripping time may be programmed and/or stored in the memory assembly (108) of FIG. 2. The tripping characteristics of the circuit may be programmed to resemble the tripping curves of the single-use fuse. The controller assembly (106) may be used to perform other additional functions, such as over and under voltage, power, etc. The system (100) provides, in use, the same safety functions as the known single-blow fuse. However, in addition, by freeing up the space that is required for the known single-blow (single-use) fuse assembly, potentially more heat zones may be accommodated.

The multi-zone heater system (101) may perform (and not limited to) the following functions on the molding system (900): (A) controlling heat required for the heat required by the extruder assembly (902) and/or the heat required by the runner system (916) and/or the heat required by the mold assembly (918) by turning the system (100) accordingly ON or OFF (as required), (B) isolating the power input and output signals, (C) isolating the power and control signals, (D) sensing and computing the current flowing through the heater assemblies (903), (E) converting the current in to a digital form for input to the controller assembly (106), (F) causing the solid-state load switch assembly (130) (solid state branch circuit protection device) to open in case of an over current condition that exceeds the preset limits for a certain time period, (G) monitoring and controlling of the operation of the multi-zone heater system (101) and/or the system (100), (H) communicating to a remote computer system (not depicted and known) through an industrial bus and providing status of detected current values, (I) turning ON the solid-state load switch assembly (130) responsive to receiving a remote RESET signal.

### ADDITIONAL DESCRIPTION

The following clauses are offered as further description of the examples of the system (100): Clause (1): a system (100), comprising: a load-disconnection assembly (104) being configured to disconnect flow of electrical power from a line-power terminal (899) for the case where a load-regulation assembly (102) fails to regulate the flow of electrical power from the line-power terminal (899), the load-regulation assembly (102) configured to regulate the flow of electrical power from the line-power terminal (899). Clause (2): a system (100), comprising: a load-regulation assembly (102) configured to regulate flow of electrical power from a line-power terminal (899); and a load-disconnection assembly (104) being configured to disconnect the flow of electrical power from the line-power terminal (899) for the case where the load-regulation assembly (102) fails to regulate the flow of electrical power from the line-power terminal (899). Clause (3): the system (100) of any clause mentioned in this paragraph, wherein: the load-disconnection assembly (104) and the load-regulation assembly (102) are configured in combination to connect (directly or indirectly) the line-power terminal (899) to a load assembly (901) so that electrical power flows from the line-power terminal (899) to the load assembly (901). Clause (4): the system (100) of any clause mentioned in this paragraph, further comprising: a controller assembly (106) being configured to send a disconnection command signal (204) to be received by the load-disconnection assembly (104), the disconnection command signal (204) being configured to command the load-disconnection assembly (104) to disconnect the flow of electrical power from the line-power terminal (899) for the case where the load-regulation assembly (102) fails to regulate the flow of electrical power from the line-power terminal (899). Clause (5): the system (100) of any clause mentioned in this paragraph, wherein: the controller assembly (106) is configured to communicate signals with the load-disconnection assembly (104) and with the load-regulation assembly (102). Clause (6): the system (100) of any clause mentioned in this paragraph, further comprising: a controller assembly (106) being configured to send a regulation-command signal (202) to be received by the load-regulation assembly (102), the regulation-command signal (202) being configured to command the load-disconnection assembly (104) to regulate the flow of electrical power from the line-power terminal (899). Clause (7): the system (100) of any clause mentioned in this paragraph, wherein: the load-disconnection assembly (104) is configured to: couple to the line-power terminal (899), and disconnect the flow of electrical power from the line-power terminal (899) in response to receiving a disconnection command signal (204), the disconnection command signal (204) configured to command the load-disconnection assembly (104) to disconnect the flow of electrical power from the line-power terminal (899). Clause (8): the system (100) of any clause mentioned in this paragraph, wherein: the load-regulation assembly (102) is configured to: couple to a load assembly (901), couple to the load-disconnection assembly (104), so that electrical power flows, in use, from the line-power terminal (899) to the load assembly (901) via the load-disconnection assembly (104) and the load-regulation assembly (102), and provide an indicating signal (212) configured to indicate an attribute of the electrical power associated with the flow of electrical power from the line-power terminal (899), and regulate the flow of electrical power from the line-power terminal (899) in response to receiving a regulation-command signal (202), the regulation-command signal (202) configured to command the load-regulation assembly (102) to regulate the flow of electrical power from the line-power terminal (899). Clause (9): the system (100) of any clause mentioned in this paragraph, wherein: the controller assembly (106) is configured to: couple to the load-disconnection assembly (104), couple to the load-regulation assembly (102), receive an indicating signal (212) from the load-regulation assembly (102), the indicating signal (212) configured to indicate an attribute of the electrical power associated with the flow of electrical power from the line-power terminal (899), and send a regulation-command signal (202) to the load-regulation assembly (102), the regulation-command signal (202) configured to command the load-regulation assembly (102) to regulate the flow of electrical power from the line-power terminal (899). Clause (10): the system (100) of any clause mentioned in this paragraph, wherein: for the case where the load-disconnection assembly (104) fails to operate, the controller assembly (106) is configured to: send a regulation-command signal (202) to the load-regulation assembly (102), the regulation-command signal (202) configured to command the load-regulation assembly (102) to disconnect the flow of electrical power from the line-power terminal (899). Clause (11): the system (100) of any clause mentioned in this paragraph, wherein: for the case where the load-regulation assembly (102) fails to operate, the controller assembly (106) is configured to: send the disconnection command signal (204) to the load-disconnection assembly (104), a regulation-command signal (202) is configured to command the load-disconnection assembly (104) to disconnect the flow of electrical power from the line-power terminal (899). Clause (12): the system (100) of any clause mentioned in this paragraph, wherein: for the case where the controller assembly (106) fails to communicate with the load-disconnection assembly (104), the load-regulation assembly (102) disconnects the flow of electrical power from the line-power terminal (899). Clause (13): the system (100) of any clause mentioned in this paragraph, wherein: for the case where the controller assembly (106) fails to communicate with the load-regulation assembly (102), the load-disconnection assembly (104) disconnects the flow of electrical power from the line-power terminal (899). Clause (14): the system (100) of any clause mentioned in this paragraph, wherein: the load-regulation assembly (102) is configured to disconnect the flow of electrical power from the line-power terminal (899) for the case where the load-regulation assembly (102) detects an electrical fault condition associated with the flow of electrical power from the line-power terminal (899). Clause (15): the system (100) of any clause mentioned in this paragraph, wherein: the load-disconnection assembly (104) is configured to disconnect the flow of electrical power from the line-power terminal (899) for the case where the load-regulation assembly (102) detects an electrical fault condition but fails to disconnect the flow of electrical power from the line-power terminal (899) to a load assembly (901). Clause (16): the system (100) of any clause mentioned in this paragraph, wherein: for a case where the controller assembly (106) determines that the load-regulation assembly (102) is operational, the controller assembly (106) uses the load-regulation assembly (102) to control the flow of electrical power to a load assembly (901); and for the case where the controller assembly (106) determines that the load-regulation assembly (102) is not operational, the controller assembly (106) uses the load-disconnection assembly (104) to control the flow of electrical power to the load assembly (901). Clause (17): the system (100) of any clause mentioned in this paragraph, wherein: the load-regulation assembly (102) includes: input terminals (120) being configured to connect (directly or indirectly) to the load-disconnection assembly (104); a current sensor (122) configured to detect and provide an indication of an amount of electrical current flowing from the line-power terminal (899) to a load assembly (901); a first optical-isolation assembly (124A) being connected to the current sensor (122); an analogue-to-digital converter assembly (126) being connected to the first optical-isolation assembly (124A), and the analogue-to-digital converter assembly (126) being connected to a controller assembly (106); a power-control assembly (128) being connected to the controller assembly (106); a second optical-isolation assembly (124B) being connected to the power-control assembly (128); a solid-state load switch assembly (130) being connected to the second optical-isolation assembly (124B), and the solid-state load switch assembly (130) being configured to permit the flow of electrical power from the line-power terminal (899) to the load assembly (901), and also configured to disconnect the flow of electrical power from the line-power terminal (899) to the load assembly (901); and output terminals (132) being configured to connect (directly or indirectly) the solid-state load switch assembly (130) to the load assembly (901). Clause (18): the system (100) of any clause mentioned in this paragraph, further comprising: a thermal-sensor assembly (134) being configured to sense an amount of temperature of a load assembly (901), and the thermal-sensor assembly (134) being connected to the controller assembly (106). Clause (19): the system (100) of any clause mentioned in this paragraph, further comprising: an interface circuit (136) connecting the controller assembly (106) to the load-disconnection assembly (104).

It will be appreciated that for the purposes of this document, the phrase “includes (but is not limited to)” is equivalent to the word “comprising.” The word “comprising” is a transitional phrase or word that links the preamble of a patent claim to the specific elements set forth in the claim that define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim.

It will be appreciated that the assemblies and modules described above may be connected with each other as may be required to perform desired functions and tasks that are within the scope of persons of skill in the art to make such combinations and permutations without having to describe each one in explicit terms. There is no particular assembly, components, or software code that is superior to any of the equivalents available to the art. There is no particular mode of practicing the inventions and/or examples of the invention that is superior to others, so long as the functions may be performed. It is believed that all the crucial aspects of the invention have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (and is not limited to)” is equivalent to the word “comprising.” It is noted that the foregoing has outlined the non-limiting embodiments (examples). The description is made for particular non-limiting embodiments (examples). It is understood that the non-limiting embodiments are merely illustrative as examples.

What is claimed is:

1. A system (100), comprising:
a load-disconnection assembly (104) being configured to disconnect flow of electrical power from a line-power terminal (899) for the case where a load-regulation assembly (102) fails to regulate the flow of electrical power from the line-power terminal (899), the load-regulation assembly (102) configured to regulate the flow of electrical power from the line-power terminal (899).

2. A system (100), comprising:
a load-regulation assembly (102) configured to regulate flow of electrical power from a line-power terminal (899); and
a load-disconnection assembly (104) being configured to disconnect the flow of electrical power from the line-power terminal (899) for the case where the load-regulation assembly (102) fails to regulate the flow of electrical power from the line-power terminal (899).

3. The system (100) of any one of claim 1 and claim 2, wherein:
the load-disconnection assembly (104) and the load-regulation assembly (102) are configured in combination to connect the line-power terminal (899) to a load assembly (901) so that electrical power flows from the line-power terminal (899) to the load assembly (901).

4. The system (100) of any one of claim 1 and claim 2, further comprising:
a controller assembly (106) being configured to send a disconnection command signal (204) to be received by the load-disconnection assembly (104), the disconnection command signal (204) being configured to command the load-disconnection assembly (104) to disconnect the flow of electrical power from the line-power terminal (899) for the case where the load-regulation assembly (102) fails to regulate the flow of electrical power from the line-power terminal (899).

5. The system (100) of claim 4, wherein:
the controller assembly (106) is configured to communicate signals with the load-disconnection assembly (104) and with the load-regulation assembly (102).

6. The system (100) of any one of claim 1 and claim 2, further comprising:
a controller assembly (106) being configured to send a regulation-command signal (202) to be received by the load-regulation assembly (102), the regulation-command signal (202) being configured to command the load-disconnection assembly (104) to regulate the flow of electrical power from the line-power terminal (899).

7. The system (100) of any one of claim 1 and claim 2, wherein:
the load-disconnection assembly (104) is configured to:
couple to the line-power terminal (899), and
disconnect the flow of electrical power from the line-power terminal (899) in response to receiving a disconnection command signal (204), the disconnection command signal (204) configured to command the load-disconnection assembly (104) to disconnect the flow of electrical power from the line-power terminal (899).

8. The system (100) of any one of claim 1 and claim 2, wherein:
the load-regulation assembly (102) is configured to:
couple to a load assembly (901),
couple to the load-disconnection assembly (104), so that electrical power flows, in use, from the line-power terminal (899) to the load assembly (901) via the load-disconnection assembly (104) and the load-regulation assembly (102), and
provide an indicating signal (212) configured to indicate an attribute of the electrical power associated with the flow of electrical power from the line-power terminal (899), and
regulate the flow of electrical power from the line-power terminal (899) in response to receiving a regulation-command signal (202), the regulation-command signal (202) configured to command the load-regulation assembly (102) to regulate the flow of electrical power from the line-power terminal (899).

9. The system (100) of claim 4, wherein:
the controller assembly (106) is configured to:
couple to the load-disconnection assembly (104),
couple to the load-regulation assembly (102),
receive an indicating signal (212) from the load-regulation assembly (102), the indicating signal (212) configured to indicate an attribute of the electrical power associated with the flow of electrical power from the line-power terminal (899), and
send a regulation-command signal (202) to the load-regulation assembly (102), the regulation-command signal (202) configured to command the load-regulation assembly (102) to regulate the flow of electrical power from the line-power terminal (899).

10. The system (100) of claim 4, wherein:
for the case where the load-disconnection assembly (104) fails to operate, the controller assembly (106) is configured to:
send a regulation-command signal (202) to the load-regulation assembly (102), the regulation-command signal (202) configured to command the load-regulation assembly (102) to disconnect the flow of electrical power from the line-power terminal (899).

11. The system (100) of claim 4, wherein:
for the case where the load-regulation assembly (102) fails to operate, the controller assembly (106) is configured to:
send the disconnection command signal (204) to the load-disconnection assembly (104), a regulation-command signal (202) is configured to command the load-disconnection assembly (104) to disconnect the flow of electrical power from the line-power terminal (899).

12. The system (100) of claim 4, wherein:
for the case where the controller assembly (106) fails to communicate with the load-regulation assembly (102), the load-disconnection assembly (104) disconnects the flow of electrical power from the line-power terminal (899).

13. The system (100) of claim 4, wherein:
for the case where the controller assembly (106) fails to communicate with the load-disconnection assembly (104), the load-regulation assembly (102) disconnects the flow of electrical power from the line-power terminal (899).

14. The system (100) of any one of claim 1 and claim 2, wherein:
the load-regulation assembly (102) is configured to disconnect the flow of electrical power from the line-power terminal (899) for the case where the load-regulation assembly (102) detects an electrical fault condition associated with the flow of electrical power from the line-power terminal (899).

15. The system (100) of any one of claim 1 and claim 2, wherein:
the load-disconnection assembly (104) is configured to disconnect the flow of electrical power from the line-power terminal (899) for the case where the load-regulation assembly (102) detects an electrical fault condition but fails to disconnect the flow of electrical power from the line-power terminal (899) to a load assembly (901).

16. The system (100) of claim 4, wherein:
for a case where the controller assembly (106) determines that the load-regulation assembly (102) is operational, the controller assembly (106) uses the load-regulation assembly (102) to control the flow of electrical power to a load assembly (901).

17. The system (100) of any one of claim 1 and claim 2, wherein:
the load-regulation assembly (102) includes:
input terminals (120) being configured to connect to the load-disconnection assembly (104);
a current sensor (122) configured to detect and provide an indication of an amount of electrical current flowing from the line-power terminal (899) to a load assembly (901);
a first optical-isolation assembly (124A) being connected to the current sensor (122);
an analogue-to-digital converter assembly (126) being connected to the first optical-isolation assembly (124A), and the analogue-to-digital converter assembly (126) being connected to a controller assembly (106);
a power-control assembly (128) being connected to the controller assembly (106);
a second optical-isolation assembly (124B) being connected to the power-control assembly (128);
a solid-state load switch assembly (130) being connected to the second optical-isolation assembly (124B), and the solid-state load switch assembly (130) being configured to permit the flow of electrical power from the line-power terminal (899) to the load assembly (901), and also configured to disconnect the flow of electrical power from the line-power terminal (899) to the load assembly (901); and
output terminals (132) being configured to connect the solid-state load switch assembly (130) to the load assembly (901).

18. The system (100) of claim 4, further comprising:
a thermal-sensor assembly (134) being configured to sense an amount of temperature of a load assembly (901), and the thermal-sensor assembly (134) being connected to the controller assembly (106).

19. The system (100) of claim 4, further comprising:
an interface circuit (136) connecting the controller assembly (106) to the load-disconnection assembly (104).

20. A molding system (900) having the system (100) of any preceding claim.

21. A multi-zone heater system (101) having the system (100) of any preceding claim.

22. A multi-zone heater system (101) having the system (100) of any preceding claim, wherein the system (100) is configured for controlling the heater assemblies (903) connected to a molding system (900).

23. A runner system (916) having the system (100) of any preceding claim.

24. A mold assembly (918) having the system (100) of any preceding claim.

25. A method, comprising:
regulating flow of electrical power from a line-power terminal (899); and
disconnecting the flow of electrical power from the line-power terminal (899) for the case where there is a failure to regulate the flow of electrical power from the line-power terminal (899).

26. The method of claim 25, further comprising:
controlling heating assemblies (903) of a molding system (900).

27. The method of claim 25, further comprising:
controlling motor assemblies of a molding system (900).
